(19) United States
(12) Patent Application Publication
(10) Pub. No.: US 2016/0259892 A1
(43) Pub. Date: Sep. 8, 2016

(54) SYSTEM AND METHOD FOR MANAGING DRUG DISPENSING TO PATIENTS

(71) Applicant: ABIDE TECHNOLOGIES, LLC, Forney, TX (US)

(72) Inventor: Rick WILSON, Forney, TX (US)

(21) Appl. No.: 15/059,468

(22) Filed: Mar. 3, 2016

Related U.S. Application Data
(60) Provisional application No. 62/127,315, filed on Mar. 3, 2015.

(51) Int. Cl. G06F 19/00

(52) U.S. Cl. CPC G06F 19/322; G06F 19/328

(57) ABSTRACT

A system for managing patient data for patients moving between a plurality of different patient care facilities includes a first interface for connecting to a plurality of patient care facilities to receive past patient care data. A second interface provides outputs to a current health care provider. A database stores the received past patient care data. A processor includes a set of instructions to configure the processor to monitor the past patient care data with respect to a particular patient and generate an alert to the health care provider over the second interface responsive to a determination that the past patient care data from the plurality of patient care facilities indicates a patient care problem.

### CROSS-REFERENCE TO RELATED APPLICATIONS

This application claims benefit of U.S. Provisional Application No. 62/127,315, filed Mar. 3, 2015, entitled SYSTEM AND METHOD FOR MANAGING DRUG DISPENSING TO PATIENTS (Atty. Dkt. No. RDPH-32513), the specification of which is incorporated by reference herein in its entirety.

### TECHNICAL FIELD

The present invention relates to a patient data management system, and more particularly, to a system for tracking patient and medication data from a plurality of treatment locations at a centralized point.

### BACKGROUND

Within healthcare facilities there is often in need for dispensing drugs to patients. These drugs may be for physical or psychological issues and many of these drugs comprise controlled substances under government regulations and guidelines. Patients often require a wide variety of drugs and treatment therapies. In order to make sure that drug treatment and therapies do not adversely interact with each other, there is a need for some type of management between healthcare providers and medication dispensing in order to ensure best patient care practices. Tracking patients and their clinical data as the patients move between healthcare facilities creates a need for tracking and centrally locating information to improve patient care.

### SUMMARY

The present invention, as disclosed and described herein, comprises a system for managing patient data for patients moving between a plurality of different patient care facilities includes a first interface for connecting to the plurality of patient care facilities to receive past patient care data. A second interface provides outputs to a current health care provider. A database stores the received past patient care data. A processor includes a set of instructions to configure the processor to monitor the past patient care data with respect to a particular patient and generate an alert to the health care provider over the second interface responsive to a determination that the past patient care data from the plurality of patient care facilities indicates a patient care problem.

### BRIEF DESCRIPTION OF THE DRAWINGS

For a more complete understanding, reference is now made to the following description taken in conjunction with the accompanying Drawings in which:

FIG. 1 illustrates a system for managing patient care and medication information from a central location;

FIG. 2 illustrates a block diagram of an ACT system;

FIG. 3 illustrates the operation of the decision support tools of the ACT system;

FIG. 4 illustrates alert generation by the ACT system; and

FIG. 5 illustrates 340-B functionalities within the ACT system.

### DETAILED DESCRIPTION

Referring now to the drawings, wherein like reference numbers are used herein to designate like elements throughout, the various views and embodiments of a system and method for managing drug dispensing to patients are illustrated and described, and other possible embodiments are described. The figures are not necessarily drawn to scale, and in some instances, the drawings have been exaggerated and/or simplified in places for illustrative purposes only. One of ordinary skill in the art will appreciate the many possible applications and variations based on the following examples of possible embodiments.

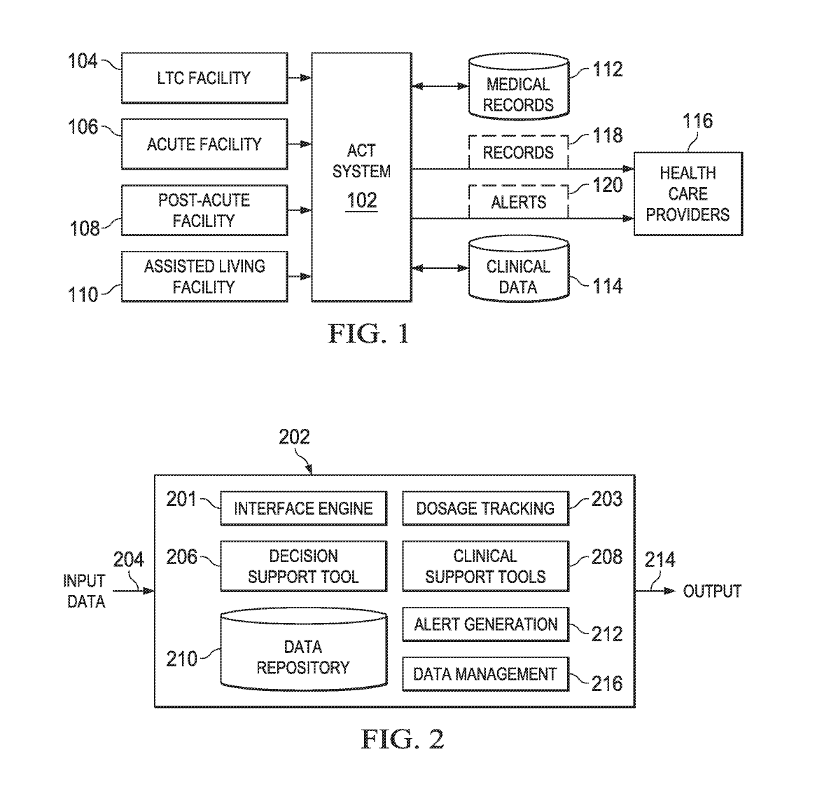

Referring now to the drawings, and more particularly to FIG. 1, there is illustrated the use of an ACT (Accountable Cloud Technology) system for managing patient care and medication information at a central location. Within healthcare facilities patient care often requires providing various types of medications and treatments to the patients in order to improve their condition. These drugs may be used to treat physical or psychological issues and in some cases comprise controlled substances that must be supplied under government regulations and guidelines. When patients are moving from treatment facility to treatment facility due to their current state of treatment, the opportunity arises for the drug and treatment therapies to adversely interact with each other. The ACT system 102 provides for management of data between healthcare providers and medication dispensing in order to ensure best patient care practices and ensure that drug and treatment therapies do not adversely interact with each other. The ACT system 102 tracks patients and their clinical data as they move between care facilities and creates a meaningful opportunity to facilitate the transformation of clinical care and improve patient care.

The ACT system 102 is a centralized data management bridge and decision support tool for use by healthcare providers caring for patients. The ACT system 102 receives input from various patient care facilities for example, long-term care facilities 104, acute care facilities 106, post-acute care facilities 108 and assisted living facilities 110. Each of these various types of facilities provide different types of care to a patient within their treatment cycle. Long-term care facilities 104 comprise facilities such as nursing homes or extended recovery facilities for patients that are in need of a high level of long term care. Acute care facilities 106 are facilities such as emergency rooms or intensive care units that are used for patients requiring an acute level of physical care. Post-acute care facilities 108 may comprise facilities that patients are transferred to once they leave the acute care facilities. For example, when a patient leaves intensive care and goes into normal hospital care. Finally, assisted living facilities 110 comprise facilities for patients that are in need of some day-to-day medical care but are still substantially able to take care of normal everyday activities on their own. Each of these potential care facilities are only examples of facilities providing input to the ACT system 102. It will be appreciated that any type of care facility providing medical care for patients and possibly dispensing medications thereto may provide a potential input to the ACT system 102.

Individuals who reside in various care facilities need acute care from time to time and will move between care facilities, such as an emergency room to a hospital, and back to long-term care facilities 104 or assisted living facility 110 after discharge. The ACT system 102 manages the individual's medical records and clinical data between the various healthcare facilities because these facilities do not share a common platform or way of managing electronically shared records. The ACT system 102 provides a central medical records database 112 and central clinical data records 114 at a centrally accessible facility. This will enable healthcare providers 116 to obtain records 118 through the ACT system 102 and its medical records database 112 allowing the providers a complete view of the patient's history though a merging of medical data across multiple facilities. Additionally, the ACT system 102 may be configured to generate alerts 122 to the healthcare providers 116 when the system 102 detects treatments or medications that may conflict with each other and cause potential harm to a patient. These alerts are generated against a decision support tool that incorporates an ACT database of clinical and pharmaceutical comparative data that will alert to potential prescription issues based upon clinical, age, medication interactions, or polypharmacy. This allows for a complete review of a patients medication profile prior to transfer to another facility reducing the average number of medications and transcription errors as the patient transfers often includes a new physician and data into a new clinical system.

Managing patient records and clinical data can be challenging between the various healthcare facilities because they do not have a common platform manner to electronically share records. The ACT system 102 assist in ensuring a consistent continuum of care therapies, medications and general health monitoring across multiple long-term care facilities 104, assisted living facilities 110, acute care facilities 106 and post care facilities 108 by importing and storing the data in a common platform that can be shared among the facilities.

Referring now to FIG. 2, there is provided a functional block diagram of the ACT system 102. The ACT system 102 receives input data 204 relating to patient care and medication from various healthcare facilities such as those described with respect to FIG. 1 through an interface engine 201 that will receive the information, convert the data and store in a common format that can be utilized by providers. This information is processed and adapted in a variety of manners within the ACT system 102. Dosage tracking 203 allows for the tracking of medication dosages provided to a patient that is transferring between the various healthcare facilities. The dosage tracking 203 additionally enables tracking of the inventory of dosages within a medication dispensing system. The ability of the ACT System 202 to integrate to Remote Automated Medication Dispensing Systems within these facilities allows for better formulary control across facilities as well as facilitating medication order reviews so that the medication can be dispensed within minutes rather than the traditional hours it can take when medications have to be prepared and delivered to the facilities. This greatly improves continuity of therapy and allows for complete pharmacy review prior to dispensing.

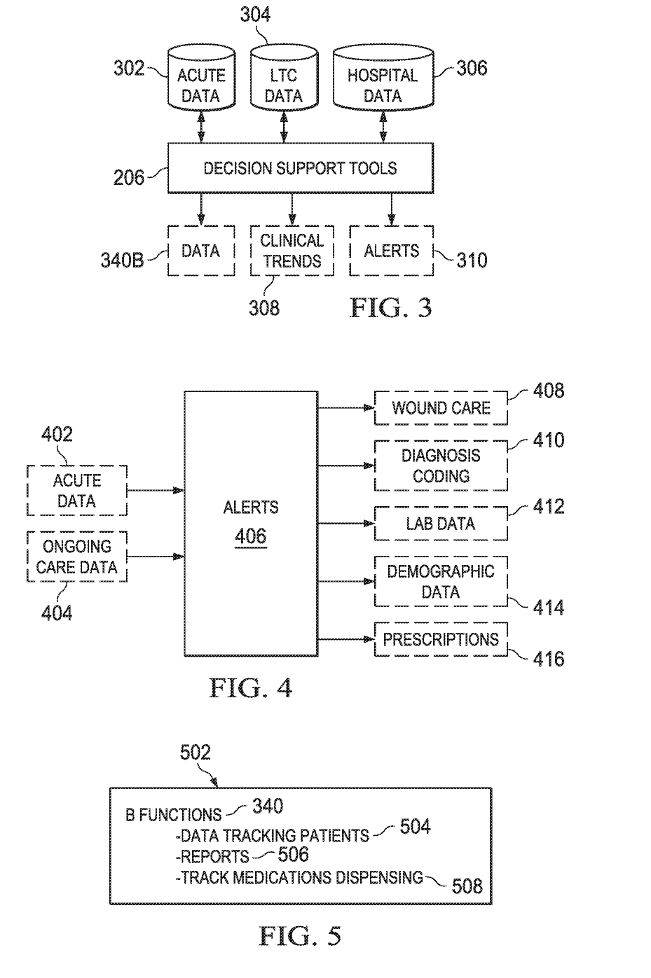

The decision support tool module 206 identifies various clinical trends to assist in patient care by comparing clinical and demographic data against information within a data repository 210. Referring also to FIG. 3, there is illustrated the various inputs and outputs functionalities of the decision support tool module 206. The decision support tool 206 incorporates databases of clinical and pharmaceutical comparative data that will alert to potential prescription issues based upon clinical, age, medication interactions, or polypharmacy. The decision support tools 206 receive acute-care data from healthcare facility acute-care databases 302. This would comprise information from places such as hospice facilities, emergency rooms and the like. The long-term care database 304 provides long-term care data relating to patients that have been kept in nursing homes and other similar types of long-term care facilities. Hospital data is provided from a hospital database 306 including information relating to patient stays within hospital for non-acute care given to a patient. While the above example describes the use of data from particular types of databases relating to acute data, LTC data and hospital data, it should be realized that the decision support tools 206 may utilize numerous other types of data for reaching decisions to assist in patient care.

The decision support tools 206 perform a number of functions using the data from each of the attached databases. The decision support tools 206 may provide clinical trends analysis 308. These clinical trends relate to the patient's current and historical diagnosis, medication history, and clinical data providing a complete medication treatment history for the providers. Additionally, the decision support tool database 210 includes clinical data information such as medication dosing guidelines (including elderly), polypharmacy, and medication interactions that will alert provider for possible medication issues. The clinical trends 308 and decision support tools 206 will assist in maintaining the highest possible level care while reducing the number of hospitalizations (readmits) for a patient. The decision support tools 206 may also generate alerts 310 relating to a number of healthcare identifiers which allow the facility/physician to take action by informing the FACILITY physician of potential medication/therapy changes that may cause issues and/or triggering additional monitoring of the patient related to a newly prescribed treatment or medication. The decision support tools 206 allow for a more seamless transition of patients within health networks using data management.

Thus, as more particularly summarized in FIG. 4, the decision support tools 206 can utilize acute-care data 402 and ongoing data 404 to generate actionable alerts 406. The alert generation function 212 provides for actionable alerts as an output 214 in the manner described above. The actionable alerts 406 relate to a number of healthcare identifiers such as wound care 408, appropriate diagnosis coding 410, lab and demographic data 414, and prescriptions 416. Each of these areas provides the potential for problems with a patient when conflicting treatments or medications are prescribed. The clinical support tools 206 will run resident clinical, vital and demographic data against a data repository to provide the actionable alerts 406 that allow healthcare facility providers and personnel to take actions by informing the physician OF medication or therapy changes, scheduling a clinic visit or for actively monitoring a patient based upon new conditions.

The ACT system 102 also includes a data management functionality 216 in order to enable the sharing AND CENTRAL MANAGEMENT of patient information between hospitals and other care facilities and for tracking patient data with respect to federal requirements such as 340-B funding tracking. Referring now also to FIG. 5, 340-B functions 502 must meet various requirements in order to obtain funding. Items such as data tracking with respect to patients 504, standardized reports 506 and the tracking of medication dispensing 508 are all required in order to obtain 340-B funding. The ACT system 102 provides a unique ability to manage the required data tracking and reporting requirements in order to adhere to the 340-B regulatory requirements by managing the complete data of the ACO (accountable care organization) resident and individual dispensed dose inventory Through the data, the ACT system 102 is able to track each medication dispensed per resident, electronically manage inventory data to the dose level and incorporate required resident demographics and clinical data in order to administer the 340-B funding across the entire continuum of the ACO.

The core of the ACT effectively links a patient's acute and LTC data and applies these two the decision support tools 206 to identify clinical trends that will assist in maintaining the highest possible level of care while reducing the number of hospitalizations. The ACT system 102 uses the repository of clinical support tools 208 to run resident clinical and demographic data against the data repository 210 to provide the actionable alerts with respect to the various healthcare identifiers discussed hereinabove.

The ACT system 102 allows healthcare providers to be more proactive in patient care and partner with the long-term care facilities and assisted living facilities using the systems data integration. Using data management, resident information is shared between the hospital and the other care facilities allowing healthcare providers a complete picture of a patient's history. The ACT system 102 provides a smooth hospital discharge in transition to a care facility by allowing for medications to be dispensed at the hospital and the prescription data entered at the care facility even before the patient has been discharged from the hospital with a complete pharmacy review of the new prescriptions prior to dispensing at the hospital. These and other types of advantages allow for a more centralized database of patient care and medication information to be access by multiple care facilities that are involved in the treatment of a patient and provide a better overall patient care experience.

It will be appreciated by those skilled in the art having the benefit of this disclosure that this system and method for managing drug dispensing to patients provides a centralized patient and medication management. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A system for managing patient data for patients moving between a plurality of different patient care facilities, comprising:
a first interface for connecting to a plurality of patient care facilities to receive past patient care data;
a second interface for providing outputs to a current health care provider;
a database for storing the received past patient care data;
a processor including a set of instructions to configure the processor to monitor the past patient care data with respect to a particular patient and generate an alert to the health care provider over the second interface responsive to a determination that the past patient care data from the plurality of patient care facilities indicates a patient care problem.

2. The system of claim 1, wherein the set of instructions further configures the processor to track medication dosages provided to the particular patient responsive to the past patient care data.

3. The system of claim 1, wherein the set of instructions further configures the processor to determine past patient care data received from the plurality of patient care facilities is related to the particular patient and associating the data with the particular patient within the database.

4. The system of claim 1, wherein the set of instructions further configures the processor to track 340-B funding data within the past patient care data.

5. The system of claim 5, wherein the set of instructions further configures the processor to generate 340-B funding reports from the past patient care data.

6. The system of claim 1, wherein the alert relates to at least one of wound care, diagnosis coding, entered lab data, entered demographic data, prescription and medication data.

7. The system of claim 1, wherein the past patient care data from the plurality of patient care facilities comprises acute care facility data, long term care facility data and hospital facility data.

8. A system for managing patient data for patients moving between a plurality of different patient care facilities, comprising:
a first interface for connecting to a plurality of patient care facilities to receive past patient care data, wherein the past patient care data from the plurality of patient care facilities comprises acute care facility data, long term care facility data and hospital facility data;
a second interface for providing outputs to a current health care provider;
a database for storing the received past patient care data;
a database of medication interactions and dosing;
a processor including a set of instructions to configure the processor to monitor the past patient care data with respect to a particular patient and generate an alert to the health care provider over the second interface responsive to a determination that the past patient care data from the plurality of patient care facilities indicates a patient care problem, the set of instructions further configuring the processor to determine past patient care data received from the plurality of patient care facilities is related to the particular patient and associating the data with the particular patient within the database.

9. The system of claim 8, wherein the set of instructions further configures the processor to track medication dosages provided to the particular patient responsive to the past patient care data.

10. The system of claim 8, wherein the set of instructions further configures the processor to track 340-B funding data within the past patient care data.

11. The system of claim 10, wherein the set of instructions further configures the processor to generate 340-B funding reports from the past patient care data.

12. The system of claim 8, wherein the alert relates to at least one of wound care, diagnosis coding, entered lab data, entered demographic data, prescriptions.

13. A method for managing patient data for patients moving between a plurality of different patient care facilities, comprising:
receiving past patient care data from a plurality of patient care facilities;
storing the received past patient care data;
monitoring the past patient care data with respect to a particular patient;
generating an alert to the health care provider responsive to a determination that the past patient care data from the plurality of patient care facilities indicates a patient care problem; and
forwarding the alert to a current health care provider.

14. The method of claim 13 further including tracking medication dosages provided to the particular patient responsive to the past patient care data.

15. The method of claim 13 further including:
determining past patient care data received from the plurality of patient care facilities is related to the particular patient; and
associating the data with the particular patient within the database.

16. The method of claim 13 tracking 340-B funding data within the past patient care data.

17. The method of claim 16 further including generating 340-B funding reports from the past patient care data.

18. The method of claim 13, wherein the alert relates to at least one of wound care, diagnosis coding, entered lab data, entered demographic data, prescriptions.

19. The method of claim 13, wherein the past patient care data from the plurality of patient care facilities comprises acute care facility data, long term care facility data and hospital facility data.
